(19) United States
(12) Patent Application Publication
(10) Pub. No.: US 2013/0058571 A1
(43) Pub. Date: Mar. 7, 2013

(54) IMAGE FILE COMPRESSION SYSTEM AND METHOD

(71) Applicants: Ju-yun JANG, Hwaseong-si (KR); Bugalia NISHANT, Utter Pradesh (IN); Singh NIDHI, Haryana (IN); Sung-hee CHO, Seoul (KR)

(72) Inventors: Ju-yun JANG, Hwaseong-si (KR); Bugalia NISHANT, Utter Pradesh (IN); Singh NIDHI, Haryana (IN); Sung-hee CHO, Seoul (KR)

(73) Assignee: SAMSUNG ELECTRONICS CO., LTD., Suwon-si (KR)

(21) Appl. No.: 13/600,766

(22) Filed: Aug. 31, 2012

(30) Foreign Application Priority Data
Sep. 1, 2011 (KR) 2011-0088695

(51) Int. Cl. G06K 9/36

(52) U.S. Cl. 382/166

(57) ABSTRACT

A system and method for image file compression method are provided. The method for compressing an image file, to which data corresponding to a plurality of different color channels for each pixel are assigned, includes reconstructing the image file so that pieces of data corresponding to the same color channel from among pieces of data corresponding to different color channels of each pixel are consecutively arranged, and compressing the reconstructed image file by applying a frequency compression scheme to the image file.

### CROSS-REFERENCE TO RELATED APPLICATIONS

This application claims priority from Korean Patent Application No. 2011-0088695, filed Sep. 1, 2011, in the Korean Intellectual Property Office, the disclosure of which is incorporated herein by reference in its entirety.

### BACKGROUND

1. Field

Methods and apparatuses consistent with exemplary embodiments herein relate to a system and method for image file compression and more particularly, to an image file compression system and method employing a frequency compression scheme.

2. Description of the Related Art

A squashing compression scheme is frequently used to compress a data file in the Linux environment.

The squashing compression scheme is typically performed based on a gzip compression scheme, namely, a frequency compression scheme. A Lempel-Ziv-Markov chain algorithm (LZMA) compression scheme, and a Lempel-Ziv-Oberhumer (LZO) compression scheme may be additionally applied according to a Linux kernel version.

The squashing compression scheme is designed for a general case, regardless of the characteristics of data to be compressed.

However, since the squashing compression scheme is performed based on the frequency compression scheme, a compression ratio may be increased if similar data is repeated. Accordingly, a problem exists in that, if values of data, for example bitmap data, corresponding to an alpha (A) channel, a red (R) channel, a green (G) channel, and a blue (B) channel are consecutively stored, the compression ratio may be significantly reduced due to a reduction in a similarity between neighboring data.

### SUMMARY

An aspect of the exemplary embodiments relates to reconstruction of an image file through an image file compression system and method for increasing a compression ratio of an image file, based on a frequency compression scheme.

A method for compressing an image file to which data is assigned which corresponds to a plurality of different color channels for each pixel, according to an exemplary embodiment, includes reconstruction of the image file so that pieces of data which correspond to the same color channel from among pieces of data which correspond to different color channels of each pixel are consecutively arranged, and compressing the reconstructed image file by applying a frequency compression scheme to the image file.

The reconstruction of the image file may include dividing each pixel according to rows, and reconstructing the image file so that pieces of data which correspond to the same color channel from among pieces of data which correspond to different color channels of each pixel in each of the rows are consecutively arranged.

The reconstruction of the image file may include setting, as reference data, first data from among a plurality of pieces of data which correspond to a single color channel from among the different color channels, selecting a corresponding color value as a value of the first data set as the reference data, selecting, as a value of each of the other data, a difference value between the first data and each of the other data, consecutively arranging the selected values, and reconstructing the image file.

The different color channels may include at least one of an alpha (A) channel, a red (R) channel, a green (G) channel, and a blue (B) channel.

The image file may include a bitmap data file.

The frequency compression scheme may include a squashing compression scheme.

A system for compressing an image file to which data corresponding to a plurality of different color channels for each pixel are assigned, according to an exemplary embodiment, includes a file reconstruction unit which reconstructs the image file so that pieces of data corresponding to the same color channel from among pieces of data corresponding to different color channels of each pixel are consecutively arranged. The system further includes a file compression unit which compresses the reconstructed image file by applying a frequency compression scheme to the image file.

The file reconstruction unit may divide each pixel according to rows, and may reconstruct the image file so that pieces of data corresponding to the same color channel from among pieces of data corresponding to different color channels of each pixel in each of the rows, may be consecutively arranged.

The file reconstructing unit may set, as reference data, first data from among a plurality of pieces of data corresponding to a single color channel from among the different color channels, may select a corresponding color value as a value of the first data set as the reference data, may select, as a value of each of the other data, a difference value between the first data and each of the other data, may consecutively arrange the selected values, and may reconstruct the image file.

The different color channels may include at least one of an A channel, an R channel, a G channel, and a B channel.

The image file may include a bitmap data file.

The frequency compression scheme may include a squashing compression scheme.

An aspect of the exemplary embodiments may further include a method for compressing an image file which corresponds to a plurality of different color channels for each pixel, the method including reconstructing the image file so that pieces of data which correspond to the same color channel are consecutively arranged; and compressing the reconstructed image file. The reconstructed image file is compressed by applying a frequency compression scheme.

Another aspect of the exemplary embodiments may further include a system for compressing an image file to which data corresponding to a plurality of different color channels for each pixel are assigned, the system including a file reconstruction unit which reconstructs the image file so that pieces of data which correspond to the same color channel from among pieces of data which correspond to different color channels of each pixel are consecutively arranged; and a file compression unit which compresses the reconstructed image file. The reconstructed file is compressed by applying a frequency compression scheme to the image file.

### BRIEF DESCRIPTION OF THE DRAWINGS

The above and/or other aspects of the inventive concept will be more apparent by describing the disclosure of exemplary embodiments with reference to the accompanying drawings, in which:

FIG. 1 is a block diagram illustrating a configuration of an image file compression system according to an exemplary embodiment;

FIG. 2 is a view illustrating a structure of an image file to facilitate understanding of the exemplary embodiments;

FIGS. 3A through 3C are views to explain various image file reconstruction methods according to exemplary embodiments;

FIGS. 4A through 4D are views illustrating examples of the image files of FIGS. 2 through 3C; and

FIG. 5 is a flowchart illustrating an image file compression method according to an exemplary embodiment.

### DETAILED DESCRIPTION

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

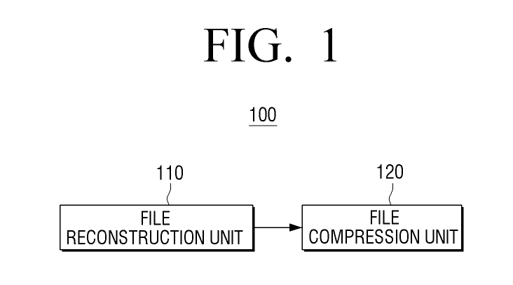

FIG. 1 is a block diagram illustrating a configuration of an image file compression system 100 according to an exemplary embodiment.

The image file compression system 100 of FIG. 1 includes a file reconstruction unit 110, and a file compression unit 120.

The file reconstruction unit 110 functions to reconstruct an image file, so that a frequency compression scheme can be efficiently applied to the image file, prior to compression of the image file.

More specifically, the file reconstruction unit 110 may reconstruct the image file, so that pieces of data corresponding to the same color channel from among pieces of data corresponding to different color channels in the image file, may be consecutively arranged.

For example, each of the pixels in the image file may include data corresponding to an alpha (A) channel, a red (R) channel, a green (G) channel, and a blue (B) channel. Here, the R channel, the G channel, and the B channel may be used to represent color information regarding red, green, and blue, respectively. The A channel may be used to represent a level of a transparency, and may contain only brightness information related to black and white.

Each of the A channel, the R channel, and the G channel, and B channel may contain information of 256 levels. For example, in a 32-bit bitmap, 4,294,967,276 colors (256×256×256×256=4,294,967,276) may be represented using the A channel, the R channel, the G channel, and the B channel.

The file reconstruction unit 110 may extract only pieces of data corresponding to A channels from among pieces of data in each of the pixels, and may reconstruct the image file so that the extracted data may be consecutively arranged.

Similarly, the file reconstruction unit 110 may reconstruct the image file, so that data corresponding to R channels may be consecutively arranged, that data corresponding to G channels may be consecutively arranged, and that data corresponding to B channels may be consecutively arranged.

In this case, the file reconstruction unit 110 may reconstruct the image file, so that pieces of data corresponding to the same color channel from among pieces of data corresponding to different color channels in pixels corresponding to each row of the image file may be consecutively arranged.

For example, data reconstruction may be performed with respect to pixels forming a first row, and data reconstruction may be performed with respect to pixels forming a second row, in the same manner as described above. Similarly, data reconstruction may be performed with respect to pixels forming the other rows.

Alternatively, the file reconstruction unit 110 may reconstruct data for each column, instead of each row. Depending on the circumstances, the file reconstruction unit 110 may reconstruct data, without dividing the data into either columns or rows.

Additionally, the file reconstructing unit 110 may set, as reference data, first data from among a plurality of pieces of data corresponding to a single color channel from among different color channels. The file reconstructing unit 110 may select a corresponding color value as a value of the first data which is set as the reference data, may select, as a value of each of the other data, a difference value between the first data and each of the other data, and may consecutively arrange the selected values.

In this case, the first data may be first data in each row.

For example, first data from among a plurality of pieces of data corresponding to A channels in a first row, and first data among a plurality of pieces of data corresponding to A channels in a second row may be set as reference data for the A channels in the first row and for the A channels in the second row, respectively. Similarly, first data from among a plurality of pieces of data corresponding to A channels in each of the other rows may be set as reference data for the A channels in a corresponding row. Similarly, reference data for the other color channels may be set in the same manner as described above.

Accordingly, first data from among pieces of data which correspond to a predetermined color channel in each row and which are consecutively arranged may have a corresponding color value. Additionally, each of the data other than the first data may have a difference value between the first data and each of the other data.

Alternatively, first data from among a plurality of pieces of data corresponding to a single color channel among different color channels may be first data of a corresponding image file.

For example, first data from among a plurality of pieces of data corresponding to A channels forming a predetermined image file may be set as reference data for the A channels. Reference data for the other color channels may be set in the same manner as described above.

Accordingly, first data from among pieces of data which correspond to a predetermined color channel in a first row and which are consecutively arranged may have a corresponding color value. Additionally, each of the other data in the first row may have a difference value between the first data and each of the other data.

The file compression unit 120 compresses the image file reconstructed by the file reconstruction unit 110, by applying the frequency compression scheme to the reconstructed image file.

Here, the frequency compression scheme may include, for example, a squashing compression scheme, a squeezing compression scheme, a crunching compression scheme, a shrinking compression scheme, and the like. Since these compression schemes are well known, only the squashing compression scheme will be briefly described.

The squashing compression scheme may employ a gzip compression scheme, a Lempel-Ziv-Markov chain algorithm (LZMA) compression scheme, a Lempel-Ziv-Oberhumer (LZO) compression scheme, and the like, according to a Linux kernel version.

The squashing compression scheme refers to a compression method of generating a table of consecutive strings while reading a file, and of referring to the table in response to the same string being found. To increase a compression efficiency, the squashing compression scheme may select an adaptive reset scheme of removing all content of the table and reconstructing the table, in response to the table being fully filled.

If the squashing compression scheme is applied to the image file reconstructed by the file reconstruction unit 110, the compression efficiency may be increased, due to a high similarity between neighboring data in the reconstructed image file.

The squashing compression scheme has been described above, but is merely an example. Accordingly, the exemplary embodiments may be applicable to any frequency compression scheme.

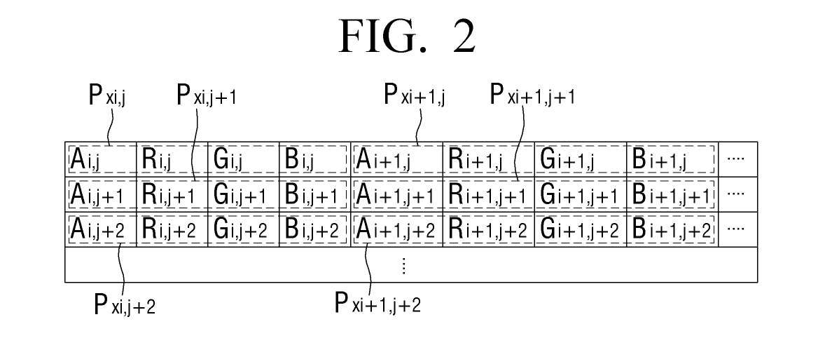

FIG. 2 is a view illustrating a structure of an image file, to facilitate an understanding of the exemplary embodiments.

The exemplary embodiments may be applied to an image file as shown in FIG. 2.

In FIG. 2, an image file to which the exemplary embodiments are applicable includes a plurality of pixels in which pieces of data corresponding to different color channels are consecutively arranged.

For example, in a 32-bit bitmap image file as shown in FIG. 2, each of pixels Pxi,j, Pxi+1,j, Pxi,j+1, Pxi+1,j+1, and the like has 32 bits, namely 4 bytes, as a combination value for A, R, G, and B. In other words, pieces of data corresponding to an A channel, an R channel, a G channel, and a B channel may be consecutively arranged, and may each have 1 byte, namely 8 bits. Here, each byte may have a value between 0 and 255 which are randomly distributed. Additionally, a similarity between values may be reduced, since color channels of neighboring bytes are different from each other.

Although not shown in FIG. 2, in a 24-bit bitmap image file, each of pixels may have 24 bits, namely 3 bytes, as a combination value for R, G, and B. In other words, pieces of data corresponding to an R channel, a G channel, and a B channel may be consecutively arranged, and may each have 1 byte, namely 8 bits. Here, each byte may have a value between 0 and 255 which are randomly distributed. Additionally, a similarity between values may be reduced, since color channels of neighboring bytes are different from each other.

Additionally, in a 16-bit bitmap image file, each of the pixels may have 16 bits, namely 2 bytes, as a combination value for R, G, and B.

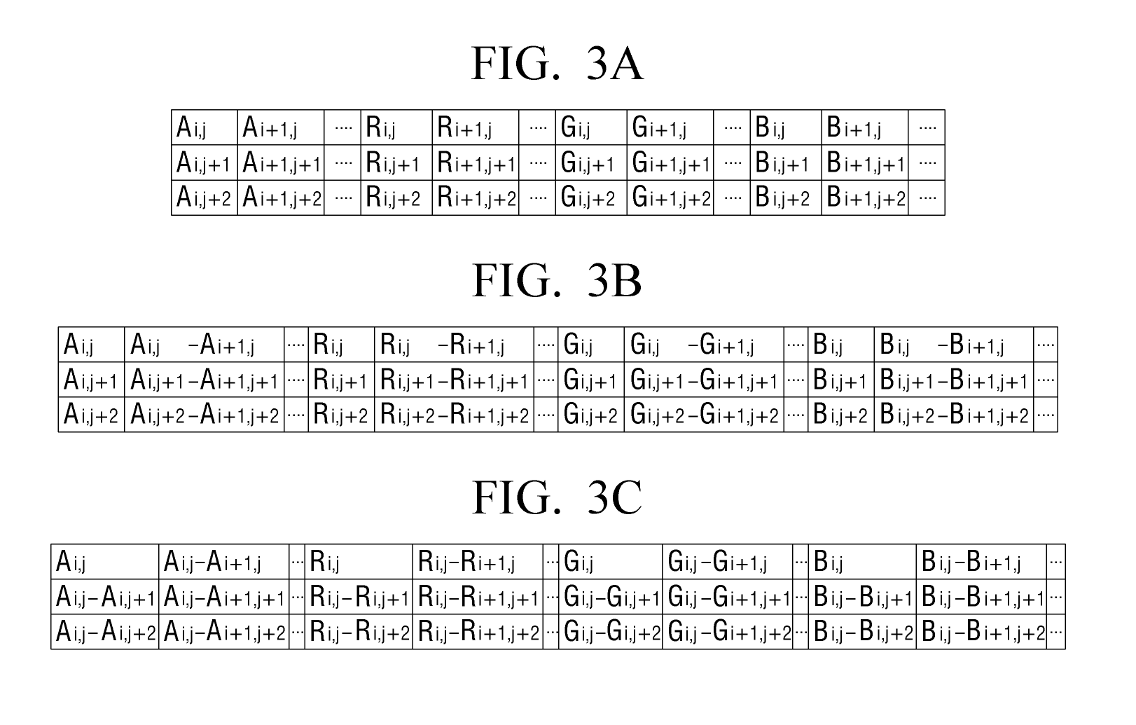

FIGS. 3A through 3C are views to explain various image file reconstruction methods according to exemplary embodiments.

For convenience of description, methods of reconstructing the 32-bit bitmap image file of FIG. 2 are described.

Referring to FIG. 3A, an image file may be reconstructed so that pieces of data corresponding to the same color channel from among pieces of data corresponding to different color channels of each pixel may be consecutively arranged.

As shown in FIG. 3A, data Ai,j corresponding to an A channel in pixel Pxi,j, data Ai+1,j corresponding to an A channel in pixel Pxi+1,j, and other data (for example, data Ai+2,j corresponding to an A channel in pixel Pxi+2,j, data Ai+3,j corresponding to an A channel in pixel Pxi+3,j, and the like) may be consecutively arranged.

Similarly, data Ri,j corresponding to an R channel of the pixel Pxi,j, data Ri+1,j corresponding to an R channel of the pixel Pxi+1,j, and other data (for example, data Ri+2,j corresponding to an R channel of the pixel Pxi+2,j, data Ri+3,j corresponding to an R channel of the pixel Pxi+3,j, and the like) may be consecutively arranged. Similarly, pieces of data corresponding to G channels and B channels may be arranged in the same manner as described above.

In this case, file reconstruction may be performed for each row of a bitmap image file, but this is merely an example. Accordingly, depending on circumstances, the file reconstruction may be performed for each column of the bitmap image file, or performed with respect to the entire image file, without dividing the image file into columns or rows.

For example, if file reconstruction is performed with respect to the entire image file, channel color values may be read from pixels of the image file, and the image file may be reconstructed so that pieces of data corresponding to the same color channel may be consecutively arranged.

Referring to FIG. 3B, an image file may be reconstructed using a difference value between reference color data and each of the other data from among pieces corresponding to the same color channel from among different color channels of each pixel.

As shown in FIG. 3B, the data Ai,j corresponding to the A channel of the pixel Pxi,j may be set as reference data. A difference value of ‘Ai,j−Ai+1,j’ between the data Ai,j and the data Ai+1,j corresponding to the A channel of the pixel Pxi+1,j, and a difference value of ‘Ai,j−Ai+2,j’ between the data Ai,j and the data Ai+2,j corresponding to the A channel of the pixel Pxi+2,j may be consecutively arranged. Similarly, difference values, for example ‘Ai,j−Ai+3,j’, ‘Ai,j−Ai+4,j’, and the like, between the data Ai,j and pieces of data other than the data ‘Ai,j, Ai+1,j, and Ai+2,j, for example data Ai+3,j, data Ai+4,j, and the like, may be consecutively arranged.

In this case, file reconstruction may also be performed for each row of a bitmap image file, but this is merely an example.

Referring to FIG. 3C, file reconstruction may be performed with respect to the entire file, instead of for each row.

For example, a first row of the image file may be reconstructed in the same manner as shown in FIG. 3B. Additionally, a second row of the image file may be reconstructed by calculating a difference value between reference data of the first row (namely, a first pixel data value) and each of channel values of a first pixel in the second row, and by applying the calculated difference value.

As shown in FIG. 3C, the data Ai,j corresponding to the A channel of the pixel Pxi,j may be set as reference data. A difference value of ‘Ai,j−Ai,j+1’ between the data Ai,j and data Ai,j+1 corresponding to an A channel of pixel Pxi, j+1, and a difference value of ‘Ai,j−Ai,j+2’ between the data Ai,j and data Ai,j+2 corresponding to an A channel of pixel Pxi, j+2 may be consecutively arranged. Similarly, difference values (for example, ‘Ai,j−Ai+3,j’, ‘Ai,j−Ai+4,j’, . . . , ‘Ai,j−Ai,j+3,“Ai,j−Ai,j+4,’ and the like) between the data Ai,j and the other data (for example, data Ai+3,j, Ai,j+3, . . . , Ai,j+4, and the like) may be consecutively arranged.

As described above, the image file reconstructed as shown in FIGS. 3A through 3C may be compressed based on the frequency compression scheme.

Therefore, a compression efficiency may be increased due to an increase in a similarity between neighboring data.

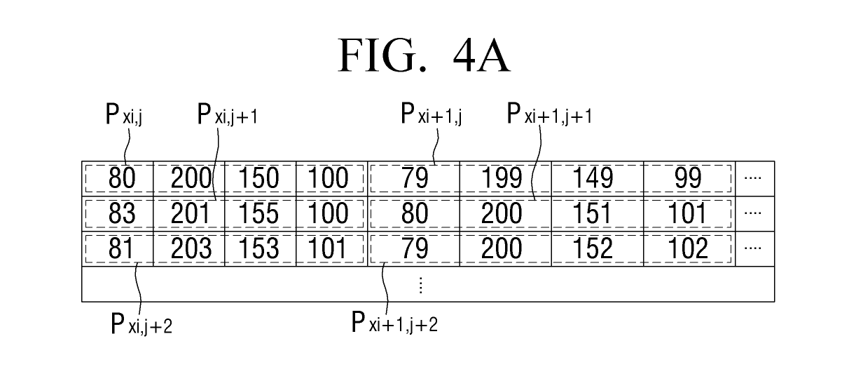

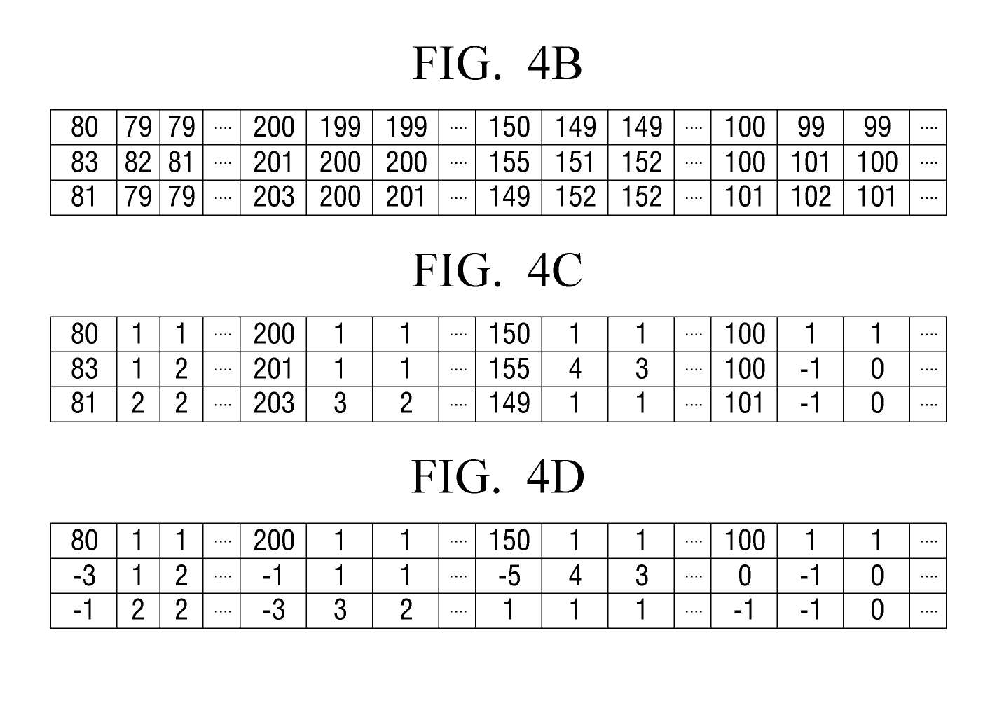

FIGS. 4A through 4D are views illustrating examples of the image files of FIGS. 2 through 3C.

FIG. 4A illustrates an example of the image file of FIG. 2.

FIG. 4B illustrates an example in which the image file reconstruction method of FIG. 3A is applied to the image file of FIG. 4A.

FIG. 4C illustrates an example in which the image file reconstruction method of FIG. 3B is applied to the image file of FIG. 4A.

FIG. 4D illustrates an example in which the image file reconstruction method of FIG. 3C is applied to the image file of FIG. 4A.

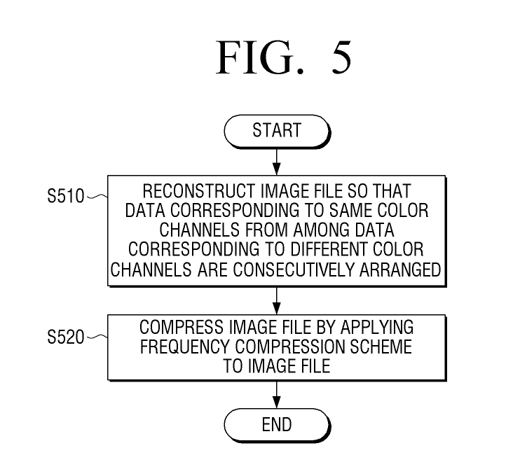

FIG. 5 is a flowchart explaining an image file compression method according to an exemplary embodiment.

The image file compression method of FIG. 5 may be applied to an image file to which pieces of data corresponding to a plurality of different color channels for each pixel are assigned.

As shown in FIG. 5, in step S510, an image file is reconstructed, so that pieces of data corresponding to the same color channel from among the pieces of data corresponding to different color channels of each of pixels in the image file, are consecutively arranged. Here, the image file may be a bitmap data file.

In step S520, the reconstructed image file is compressed by applying a frequency compression scheme to the image file. Here, a squashing compression scheme may be employed as a frequency compression scheme, but is not limited thereto. Accordingly, any frequency compression scheme, for example, a squeezing compression scheme, a crunching compression scheme, a shrinking compression scheme, and the like, may be applicable.

In step S510, the pixels in the image file may be divided according to rows, and the image file may be reconstructed so that pieces of data corresponding to the same color channel from among pieces of data corresponding to different color channels of each of pixels in each of the rows, may be consecutively arranged. However, this is not limited thereto, and accordingly it is possible to reconstruct an image file for each column, or with respect to the entire image file without dividing the image file into columns or rows.

Additionally, in step S510, first data from among a plurality of pieces of data corresponding to a single color channel among different color channels, may be set as reference data. A corresponding color value may be selected as a value of the first data which is set as the reference data, and a difference value between the first data and each of the other data may be selected as a value of each of the other data. The selected values may be consecutively arranged, and accordingly, the image file may be reconstructed.

In this case, reference data may be determined for each row or for each column, and a difference value between the reference data and each of the other data may be selected for each row or for each column, so that a value of the reference data and the selected difference values may be consecutively arranged, to reconstruct an image file.

However, this is not limited thereto, and accordingly it is possible to reconstruct an image file using color values corresponding to all pieces of data forming the image file.

Here, the different color channels may include at least one of an A channel, an R channel, a G channel, and a B channel.

Thus, it is possible to increase a compression ratio of an image file based on the frequency compression scheme.

The exemplary embodiments may include computer-readable recording media, that is, storage media including a program to implement the image file compression method described above according to the exemplary embodiments. The computer-readable recording media include all types of recording apparatuses in which data readable by a computer system is stored. Examples of the computer-readable recording media include a read-only memory (ROM), a random access memory (RAM), a CD-ROM, a magnetic tape, a floppy disk, an optical data storage, and the like. In addition, the computer-readable recording media are distributed on computer systems connected through a network, and thus a computer-readable code may be stored and executed in the computer systems in a distributed manner.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method for compressing an image file to which data is assigned which corresponds to a plurality of different color channels for each pixel, the method comprising:
reconstructing the image file so that pieces of data which correspond to the same color channel from among pieces of data which correspond to different color channels of each pixel, are consecutively arranged; and
compressing the reconstructed image file by applying a frequency compression scheme to the image file.

2. The method of claim 1, wherein the reconstructing of the image file comprises dividing each pixel according to rows, and reconstructing the image file so that pieces of data which correspond to the same color channel from among pieces of data which correspond to different color channels of each pixel in each of the rows, are consecutively arranged.

3. The method of claim 2, wherein the reconstructing comprises setting, as reference data, first data from among a plurality of pieces of data which correspond to a single color channel from among the different color channels, selecting a corresponding color value as a value of the first data set as the reference data, selecting, as a value of each of the other data, a difference value between the first data and each of the other data, consecutively arranging the selected values, and reconstructing the image file.

4. The method of claim 1, wherein the different color channels comprise at least one of an alpha (A) channel, a red (R) channel, a green (G) channel, and a blue (B) channel.

5. The method of claim 1, wherein the image file comprises a bitmap data file.

6. The method of claim 1, wherein the frequency compression scheme comprises a squashing compression scheme.

7. A system for compressing an image file to which data is assigned, which corresponds to a plurality of different color channels for each pixel, the system comprising:
a file reconstruction unit which reconstructs the image file so that pieces of data which correspond to the same color channel from among pieces of data which correspond to different color channels of each pixel, are consecutively arranged; and
a file compression unit which compresses the reconstructed image file by applying a frequency compression scheme to the image file.

8. The system of claim 7, wherein the file reconstruction unit divides each pixel according to rows, and reconstructs the image file so that pieces of data which correspond to the same color channel from among pieces of data which correspond to different color channels of each pixel in each of the rows, are consecutively arranged.

9. The system of claim 8, wherein the file reconstruction unit sets, as reference data, first data from among a plurality of pieces of data which correspond to a single color channel from among the different color channels, selects a corresponding color value as a value of the first data set as the reference data, selects, as a value of each of the other data, a difference value between the first data and each of the other data, consecutively arranges the selected values, and reconstructs the image file.

10. The system of claim 8, wherein the different color channels comprise at least one of an alpha (A) channel, a red (R) channel, a green (G) channel, and a blue (B) channel.

11. The system of claim 8, wherein the image file comprises a bitmap data file.

12. The system of claim 8, wherein the frequency compression scheme comprises a squashing compression scheme.

13. A method for compressing an image file which corresponds to a plurality of different color channels for each pixel, the method comprising: reconstructing the image file so that pieces of data which correspond to the same color channel are consecutively arranged; and compressing the reconstructed image file.

14. The method of claim 13, wherein the reconstructed image file is compressed by applying a frequency compression scheme.

15. A system for compressing an image file to which data corresponding to a plurality of different color channels for each pixel are assigned, the system comprising: a file reconstruction unit which reconstructs the image file so that pieces of data which correspond to the same color channel from among pieces of data which correspond to different color channels of each pixel are consecutively arranged; and
a file compression unit which compresses the reconstructed image file.

16. The system of claim 15, wherein the reconstructed file is compressed by applying a frequency compression scheme to the image file.
